(19) United States
(12) Patent Application Publication
(10) Pub. No.: US 2022/0163945 A1
(43) Pub. Date: May 26, 2022

(54) VIRTUAL FAB AND LAB SYSTEM AND METHOD

(71) Applicant: KING ABDULLAH UNIVERSITY OF SCIENCE AND TECHNOLOGY, Thuwal (SA)

(72) Inventor: Muhammad Mustafa HUSSAIN, Hercules, CA (US)

(21) Appl. No.: 17/602,386

(22) PCT Filed: Apr. 7, 2020
(86) PCT No.: PCT/IB2020/053321

§ 371 Date: Oct. 8, 2021

Related U.S. Application Data
(60) Provisional application No. 62/834,530, filed on Apr. 16, 2019.

(51) Int. Cl. G05B 19/4099; G06Q 50/04

(52) U.S. Cl. CPC G05B 19/4099; G05B 2219/45031; G06Q 50/04

(57) ABSTRACT

A system that connects a user to a cleanroom facility, the system including a computing device configured to receive a command from a user; and a platform remotely located from the computing device. The platform is configured to communicate with the computing device and with a cleanroom, the platform including a training module, an assessment module, and a manufacturing module. The platform is configured to, in response to receiving the command from the computing device, activate one of the training module, the assessment module, and the manufacturing module to take control over the cleanroom.

### CROSS-REFERENCE TO RELATED APPLICATIONS

This application claims priority to U.S. Provisional Patent Application No. 62/834,530, filed on Apr. 16, 2019, entitled “VIRTUAL FAB AND LAB,” the disclosure of which is incorporated herein by reference in its entirety.

### BACKGROUND

### Technical Field

Embodiments of the subject matter disclosed herein generally relate to a system and method for remotely training a user on semiconductor device fabrication processes, and more particularly, to a digital environment that offers in a unified way training capabilities in CMOS technologies before accessing a cleanroom facility, but also manufacturing access to the cleanroom.

### Discussion of the Background

With the explosion of the number of digital devices used today for communication, content generation, content consumption, monitoring, security, medical, and defense purposes, the need to build more components for these devices is increasing. Most of the digital devices used in such activities require one or more semiconductor components.

The number of techniques for fabricating a semiconductor device has also increased, with each technique being more suitable for a certain component or device than another. All these techniques require a certain number of steps to be performed in a cleanroom environment as even a small amount of dust can compromise the quality of the manufactured semiconductor device. In addition, many steps of these techniques require the use of expensive materials and/or dangerous gasses and also dealing with dangerous temperatures or pressures.

Thus, the extreme conditions under which the semiconductor components need to be manufactured and the danger posed by the various materials and manufacturing conditions necessary to grow the semiconductor components, make the training of new users for the machines present in the cleanroom very expensive and challenging. In this regard, the number of people allowed in a cleanroom facility at a given time is limited, which makes the training of the new operators difficult. In addition, the large number of manufacturing techniques, the myriad of specific conditions associated with all these techniques, and the number of machines involved for growing the various semiconductor components further contribute to the difficulty of training the new operators in the cleanroom environment.

Although there are manuals and books and videos about all these techniques, it is still difficult for the new operators to fully master the usage of these techniques and the associated machines only based on reading or seeing videos. It is the human nature to need hands-on experience in order to master a complicated task that involves many steps and many different conditions. Further, the machines used in the cleanroom are very expensive and also dangerous as they handle poisonous gases. A mistake in handling these machines or these gases can be harmful for the new operator or damaging for the machine itself.

Thus, there is a need for a platform that teaches the new operator about all these techniques, machines, and associated dangers, in an as close as possible hands-on manner, and also tests the new operator about all these aspects of semiconductor manufacturing without practically entering a cleanroom.

### BRIEF SUMMARY OF THE INVENTION

According to an embodiment, there is a system that connects a user to a cleanroom facility. The system includes a computing device configured to receive a command from a user and a platform remotely located from the computing device. The platform is configured to communicate with the computing device and with a cleanroom, the platform including a training module, an assessment module, and a manufacturing module. The platform is configured to, in response to receiving the command from the computing device, activate one of the training module, the assessment module, and the manufacturing module to take control over the cleanroom.

According to another embodiment, there is a method for connecting a user to a cleanroom facility, and the method includes receiving at a platform a command from a computing device associated with a user, determining whether the command is associated with a training module, an assessment module, or a manufacturing module of the platform, wherein the platform is remotely located from the computing device, activating, in response to the received command from the computing device, one of the training module, the assessment module, and the manufacturing module to take control over cleanroom, and interacting with the computing device and the cleanroom to train the user about one or more of plural semiconductor manufacturing processes, or to assess the user about the one or more of plural semiconductor manufacturing processes, or to manufacture an actual semiconductor device based on the one or more of plural semiconductor manufacturing processes.

According to yet another embodiment, there is a platform for connecting a user to a cleanroom facility, and the platform includes a communication module configured to receive a command from a computing device of an user, a training module configured to generate a step by step procedure for each of one or more of plural semiconductor manufacturing processes; an assessment module configured to generate one or more questions about the one or more plural semiconductor manufacturing processes; a manufacturing module configured to control one or more machines in a cleanroom for using the one or more plural semiconductor manufacturing processes; an organizational module configured to determine whether the command is associated with the training module, the assessment module, or the manufacturing module and to activate, in response to the received command, one of the training module, the assessment module, and the manufacturing module to take control over the cleanroom, and a communication module that interacts with the computing device and the cleanroom to train the user about the one or more plural semiconductor manufacturing processes, or to assess the user about the one or more plural semiconductor manufacturing processes, or to manufacture an actual semiconductor device based on the one or more plural semiconductor manufacturing processes.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a platform that provides training, assessment and manufacturing capabilities for a remote user with regard to a cleanroom;

FIG. 2 illustrates one of the screens that is offered to the user regarding one or more semiconductor manufacturing processes;

FIGS. 3A to 3N illustrate, step by step, one of the semiconductor manufacturing processes as experienced by the user through the platform;

FIG. 4 illustrates one or more haptic sensors that could be used by the user to interact, through the platform, with the cleanroom;

FIG. 5 illustrates a virtual reality device that may be used by the user to interact with the cleanroom, through the platform;

FIG. 6 schematically illustrates a system that includes the platform, a user's computing device, and the cleanroom;

FIGS. 7A and 7B illustrate various implementations of actuators for a cleanroom;

FIG. 8 is a flowchart of a method for interacting with the platform for training, assessment or manufacturing; and

FIG. 9 is a schematic diagram of a computing system in which the platform may be implemented.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a virtual environment implemented in an online platform, for training a new user with regard to various semiconductor growing techniques that are available in a cleanroom. However, the embodiments to be discussed next are not limited to an online experience, but they may be applied to a platform that also include physical elements (e.g., robots, actuators, haptic actuators) for making the learning experience more diverse and more closer to the reality.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is a platform for training a user on one of many semiconductor manufacturing processes. The user logs in into the platform using a web browser, selects one of the desired semiconductor manufacturing processes that he or she desired to master, and launches a training module for getting direct exposure to the machines used for the selected manufacturing process, the chemicals used in this process, the various conditions necessary for the manufacturing process, the steps that need to be performed with these machines, and the dangers that may appear if the machines or associated materials are not handled accordingly. Then, at the conclusion of the training part, the user is offered the possibility to be assessed about his or her acquired skills and to get feedback about the proficiency level in the selected semiconductor manufacturing process. Optionally, the user may enter a Q&A module and get more information about the selected semiconductor manufacturing process. The user may also select a manufacturing module, so that an actual cleanroom can be controlled by the platform and the user has the possibility of effectively growing a desired semiconductor component in the cleanroom. The operator of the cleanroom then ships the manufactured semiconductor component to the user. This platform, which has an online part and also a physical part, is now discussed in more detail with regard to the figures.

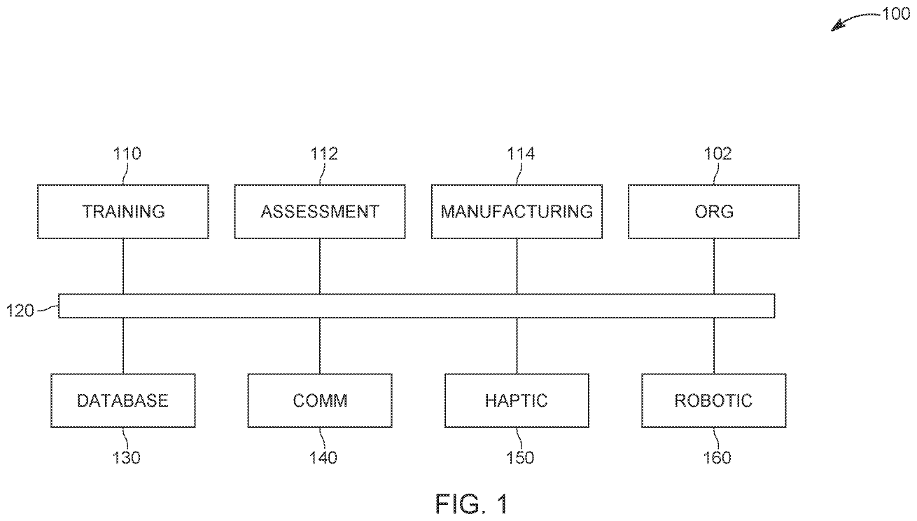

FIG. 1 illustrates an architecture of a platform 100 that provides training/assessment to an user for learning how to perform a semiconductor manufacturing process in a cleanroom environment and/or manufacturing opportunities. The platform 100 includes an organizational module 102, a training module 110, an assessment module 112, and a manufacturing module 114. All of these modules are connected to a communication bus 120. Also linked to the communication bus is a database module 130, a communication module 140, a haptic module 150, and a robotic module 160. The training module 110 is configured to allow the user to choose from any semiconductor manufacturing process and also to provide the user with all the details about the chosen semiconductor manufacturing process. After the user is remotely accessing the platform 100, the organizational module 102 provides the user, through the communication module 140, a choice for selecting the training module, or the assessment module, or the manufacturing module. If the user choses the training module, then the organizational module 102 offers the user the possibility to select one of a semiconductor manufacturing process from a plurality of semiconductor manufacturing processes. The organizational module 102 interacts with all the other modules in the platform 100 for coordinating the correct sequence of steps, for supplying the necessary information or questions, etc.

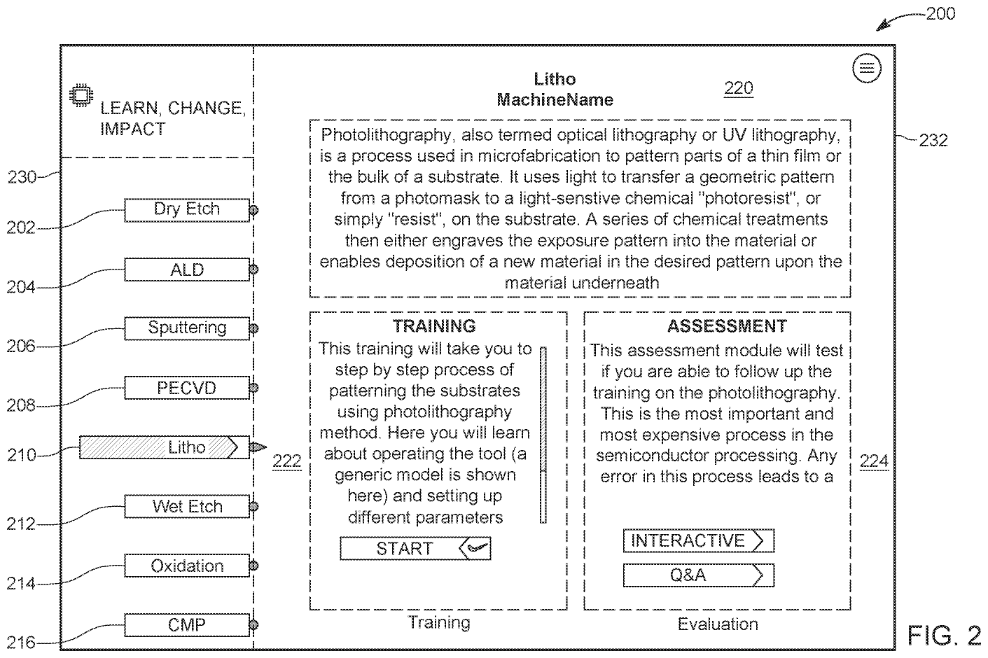

For example, as illustrated in FIG. 2, the organizational module 102 in collaboration with the training module 110 offer the user a screen 200 with plural choices of semiconductor manufacturing processes, which include, for example, Dry Etching 202, Atomic Layer Deposition (ALD) 204, Sputtering 206, Plasma-Enhanced Chemical Vapor Deposition (PECVD) 208, Photolithography 210, Wet Etching 212, Oxidation 214, and Chemical-mechanical polishing 216. These choices may be grouped in a left panel 230 of the screen 200. More semiconductor manufacturing processes may be offered by the platform 200. Once the user selects one of these processes, for example, the Litho process 210 in FIG. 2, the training module 110 reaches to the database module 130 and pulls up various information about this process. For example, a definition 220 of the process is shown at the top of the right panel 232 of the screen 200. In the same panel, the organizational module 102 may also show to the user a training screen 222 and an assessment screen 224.

The training screen 222 may show a start button that will trigger the training module 110 to provide the various training screens that are discussed later, while the assessment screen 224 may show a corresponding start button that will trigger the assessment module 112 to initiate the assessment process. Both of these modules are now described. Suppose that the user triggers the training module 110 by pressing the start button in the training screen 222 and also suppose that the user has selected the lithography method 210. The training module 110 reaches into the database 130 and pulls up all the information related to the lithography method. This information is now discussed.

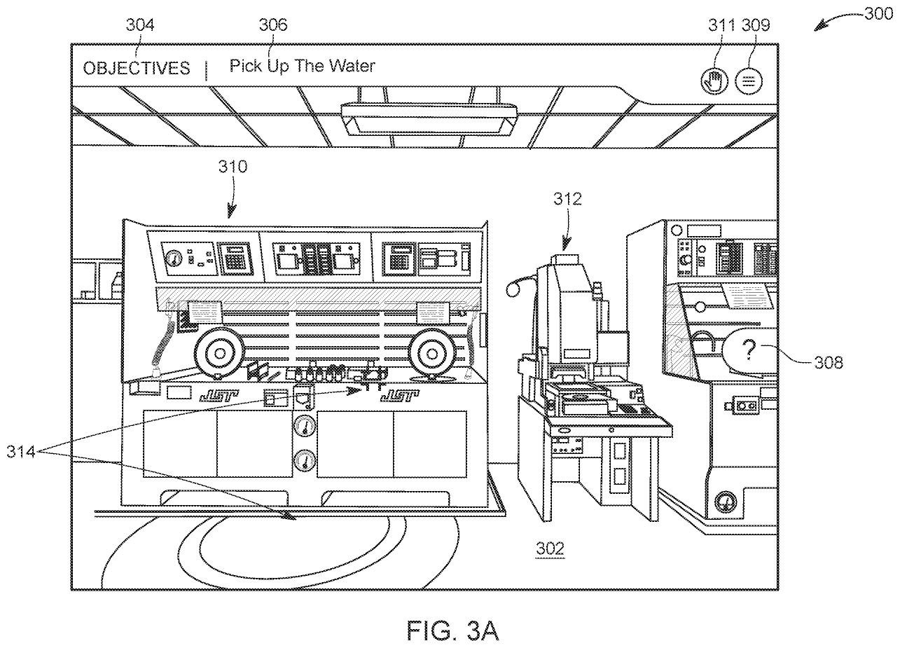

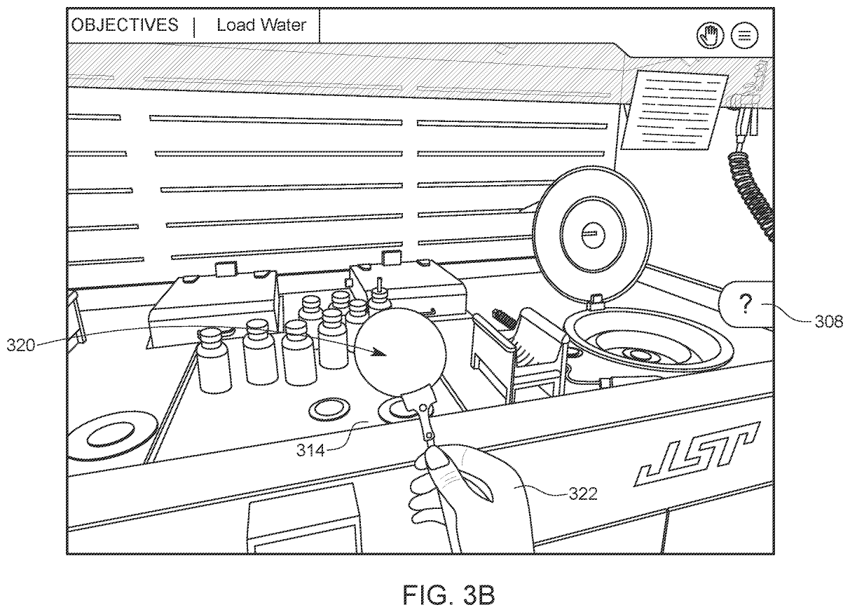

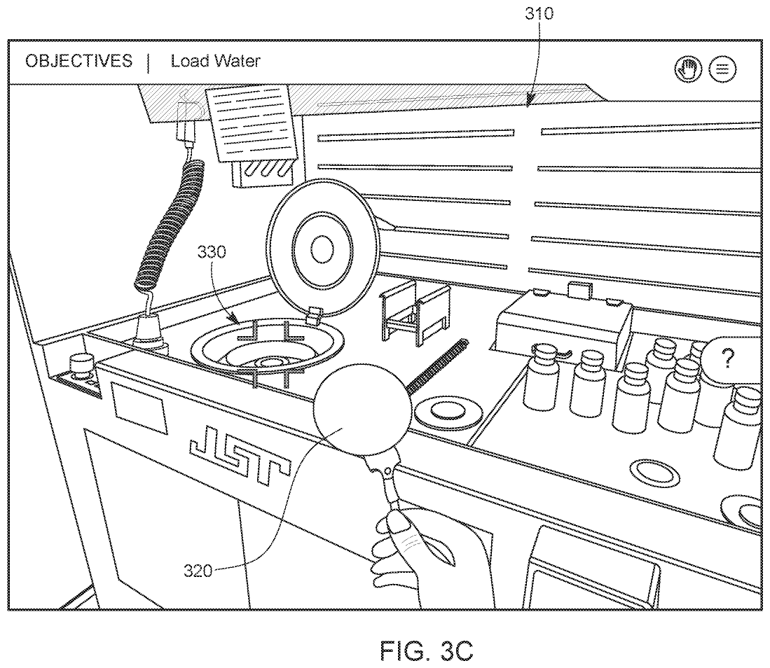

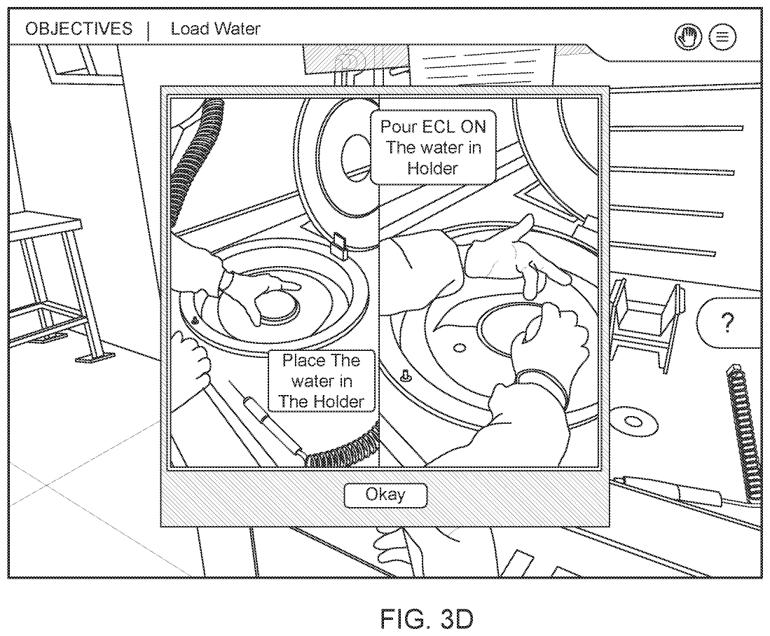

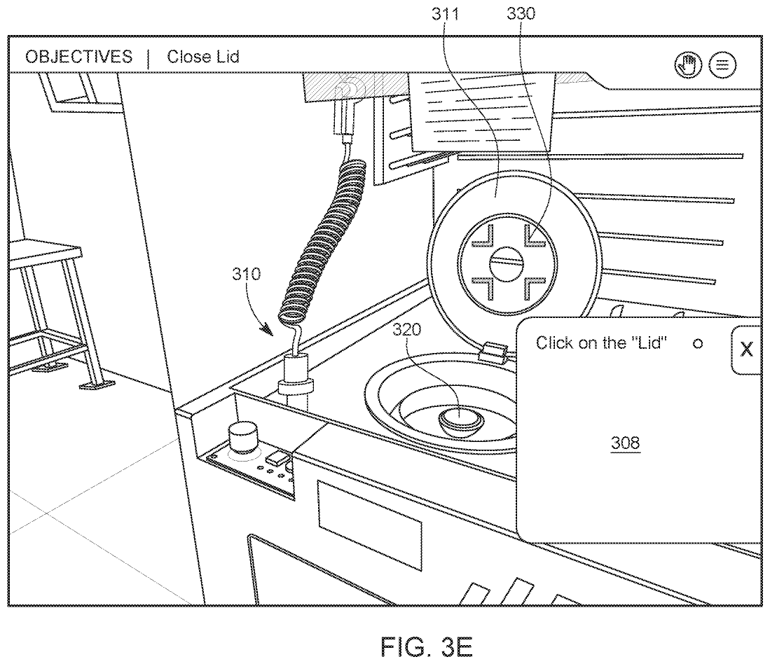

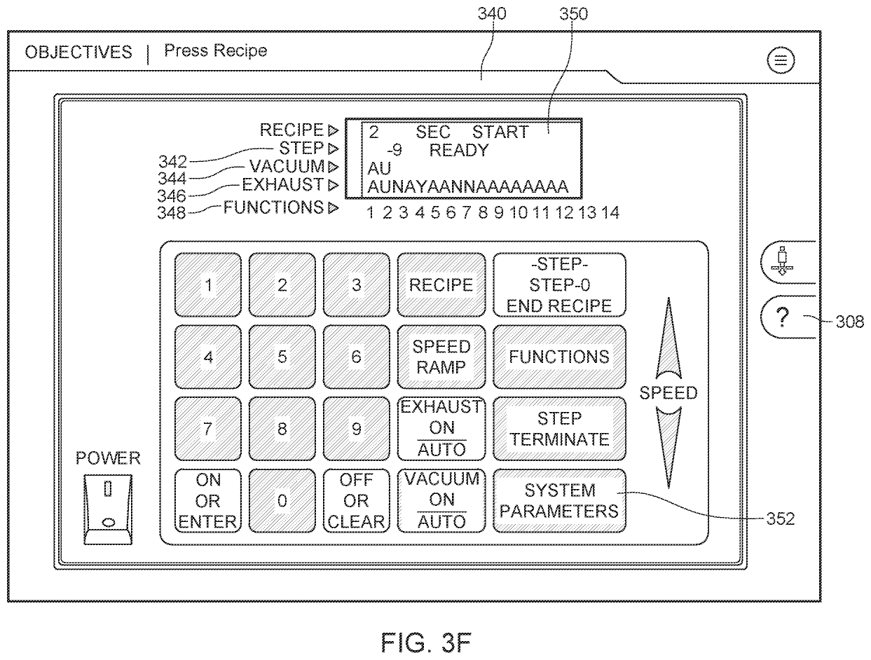

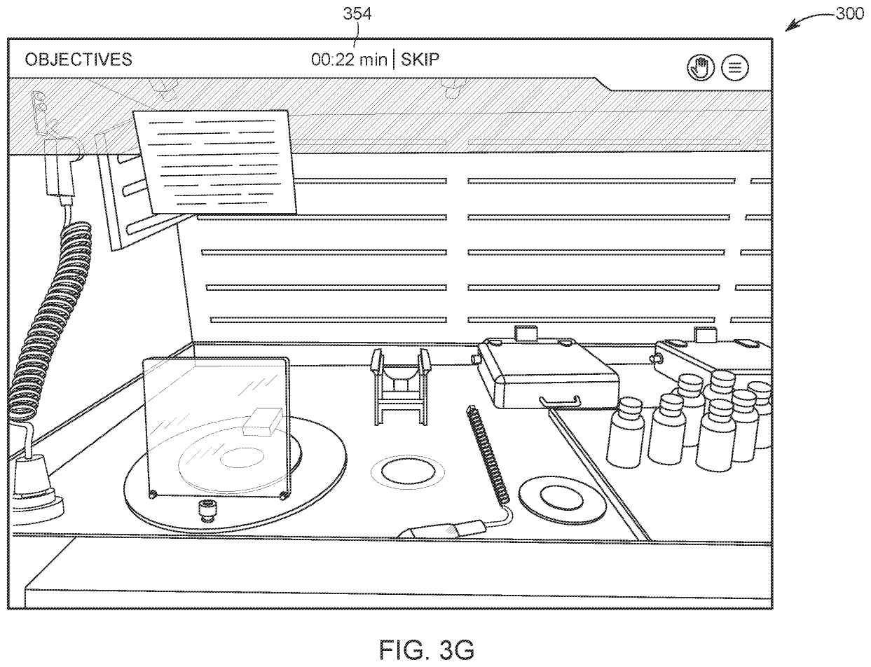

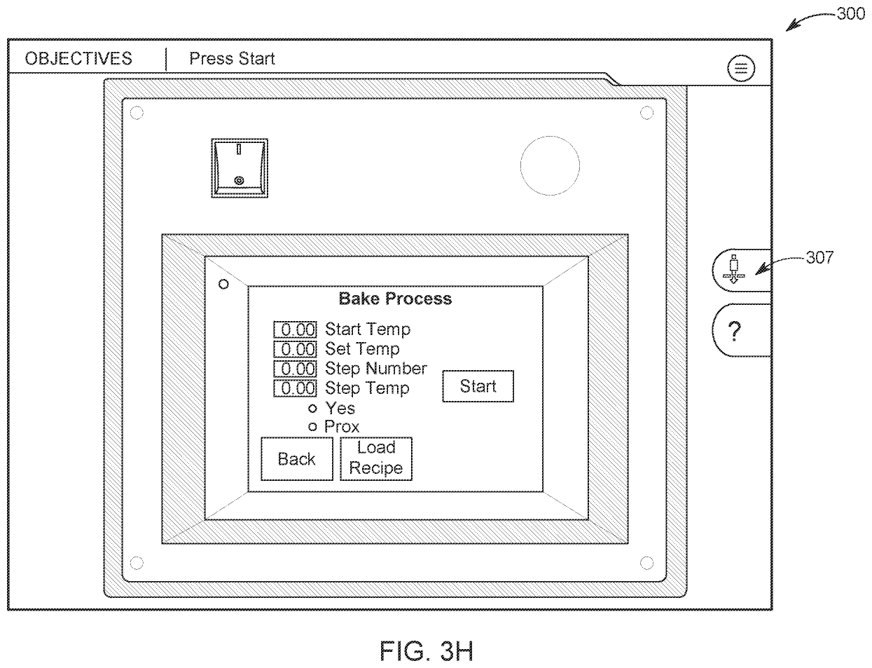

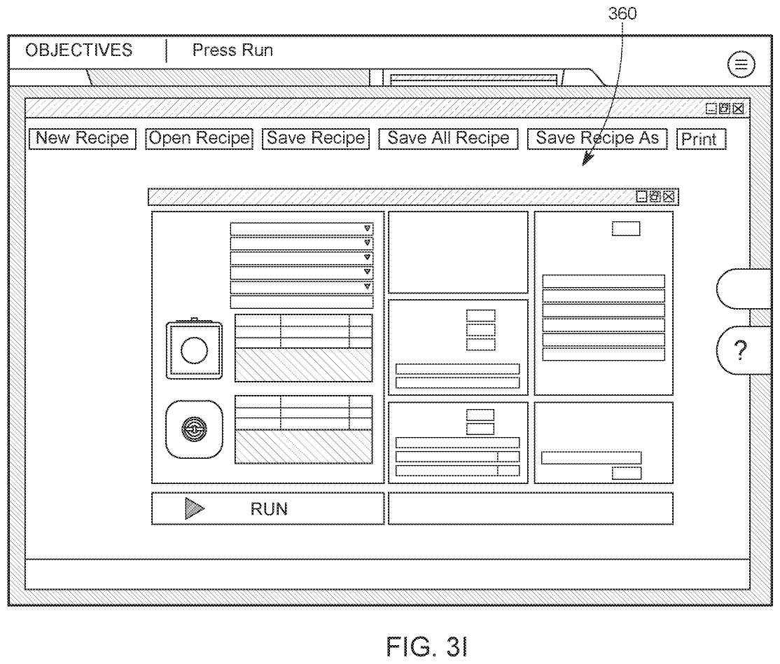

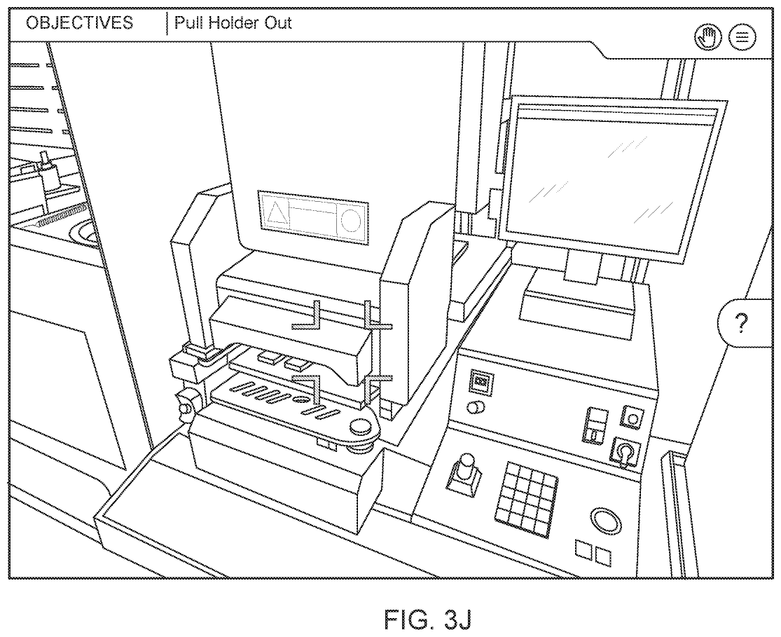

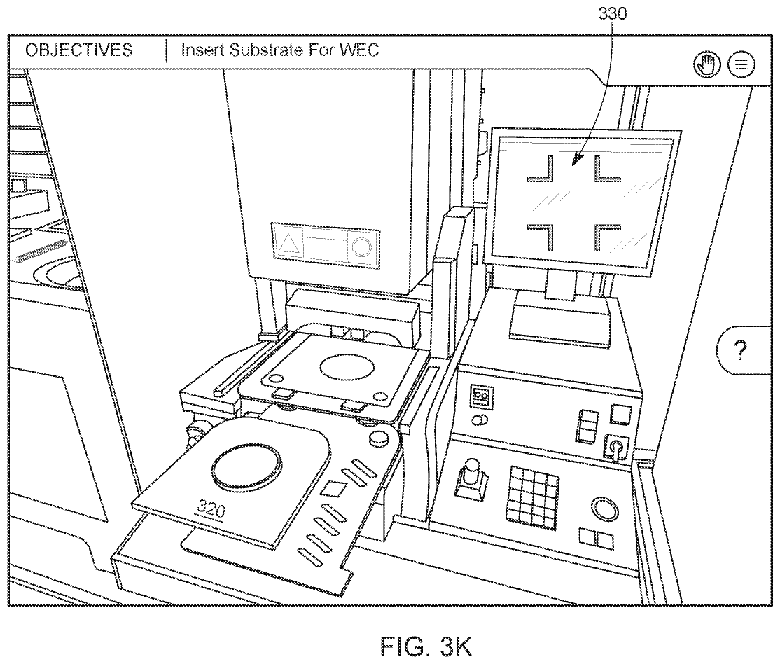

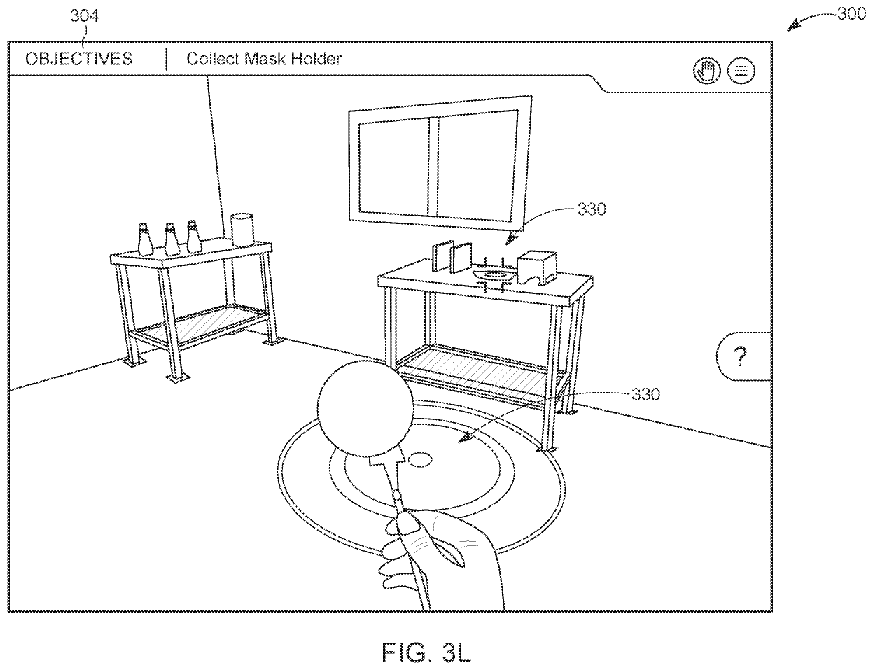

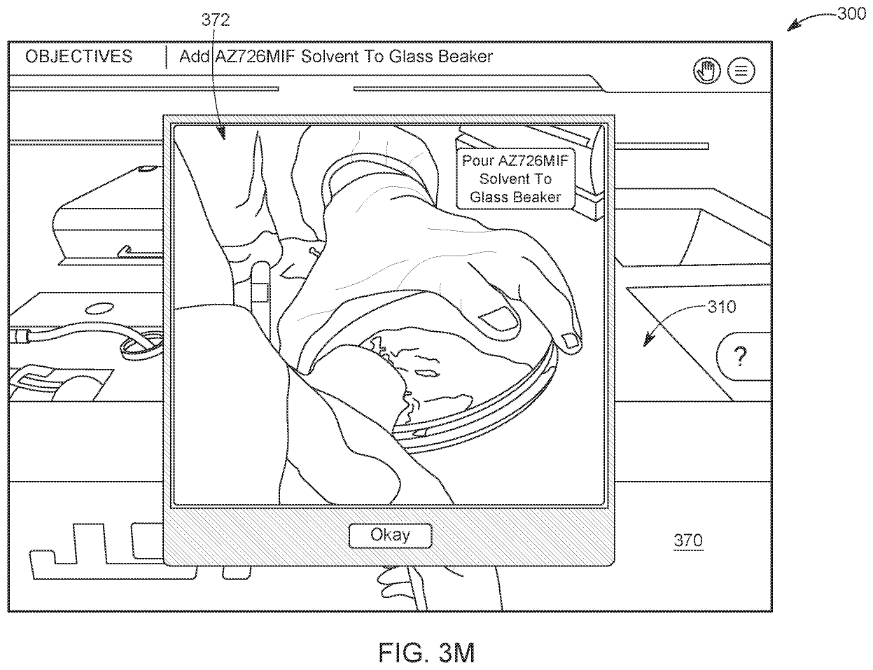

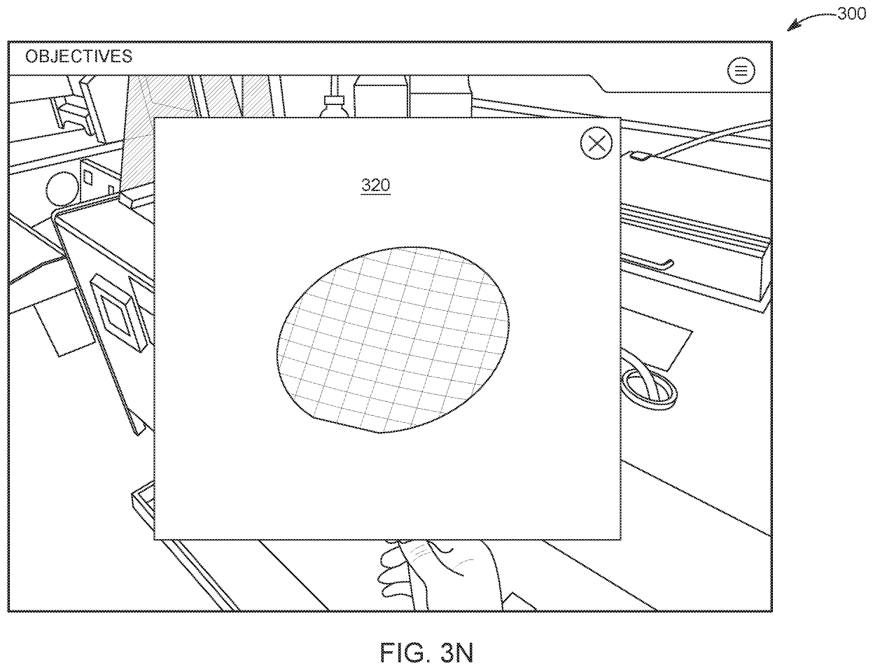

As illustrated in FIG. 3A, the training module 110 generates a lithography initial screen 300, based on the information retrieved from the database module 130. The lithography initial screen 300 may include an image of an actual lithography machine 310, a computer station 312 that may control the lithography machine 310, all of which are placed inside a cleanroom 302. The cleanroom 302 may be a virtual cleanroom, i.e., a computer generated cleanroom. In one application, the cleanroom 302 is an actual cleanroom that is controlled by the platform 100. The screen 300 may display an objective button 304, and a command field 306, that assist the user with the various tasks. The objective button 304, when pressed by the user, is configured to display information regarding the next goal that the user needs to reach. The command field 306 is configured to provide instructions to the user with regard to the next steps that the user needs to perform.

A help button 308 may also be present and provides the necessary information for the user for moving through the steps required by the lithography method. Additional buttons 309 may be present on the screen for terminating the program, saving the progress status of the user for this method, etc. An additional button 311 may provide, when pressed, an image of the wafer used for making the semiconductor device at various steps during the lithography method. One or more interaction points 314 are indicated on the screen for showing the user where he or she needs to move to complete the next step and which button to press to initiate the next step. The user uses the arrows on his or her keyboard to move to these points and the mouse for clicking on the buttons to be pressed. Other peripherals of a computing device may be used to advance through the steps of the process. It is noted that the pictures provided to the user are, in one embodiment, actual pictures taken from an actual cleanroom so that the user gets familiar with an actual facility. The same is true for all the other pictures that are shown in this simulation. In some cases, the pictures may be computer generated, but they still preserve the details of the actual pictures and also their scale.

After the user familiarizes with the environment in the cleanroom 302, the user clicks on the help button 308 and the next step to be completed is shown in a box associated with this button. For example, a first step instructs the user to move to one of the interaction point 314, as show in FIG. 3B, to pick up a processing substrate 320. The user needs to use the arrows on his or her keyboard to approach that interaction point 314 and then to click on the substrate 320 to pick it up. When this task is completed, a hand 322 is shown on the screen carrying the substrate 320. The user clicks again the help button 308 for receiving the next step to be performed. The information for all these steps is retrieved from the database module 130 and managed by the training module 110 in collaboration with the organizational module 102.

Next, the user is instructed to take the substrate 320 and to place it into the lithography machine 310, at the interaction point 330 shown in FIG. 3C. The user uses the arrows on the keyboards to move to that interaction point and the mouse to place the substrate 320 at the desired position. The training module supplies actual pictures of the machine and of the substrate when placed in the machine, as illustrated in FIG. 3D, with one or more explanations. These pictures may be superimposed over the picture of the cleanroom. After the substrate 320 is placed in the machine 310, as illustrated in FIG. 3E, the help button 308 instructs the user about the next step to be completed, for example, to close the lid 311, which is indicated by the interaction point 330. Note that for some processing methods, prior to opening the chamber in which the substrate needs to be placed, the chamber needs to be vented so that the various gases that might be stored there are not discharged into the cleanroom, to harm the user. For those methods, the help button 308 instructs the user to first vent the chamber and then only allows the chamber to be open. All these steps are method dependent and stored in the database module 130.

After the lid 311 has been closed and the substrate 320 is in position to be processed, the training module 110 displays a procedure and control screen 340, as illustrated in FIG. 3F, so that the user can selected a required recipe 342, a certain step 344, the vacuum 346 to be generated inside the chamber, and various other functions 348 associated with the selected process. All these steps are displayed on a monitor 350 and plural buttons 352 are also displayed so that the user can further adjust any of these parameters. The user can control any parameter of the chamber and the lithography machine from this console. In case that the user does not know what step or parameter to adjust or select, the help button 308 provides hints to that effect. In one application, all the steps and parameters that need to be adjusted by the user are supplied by the help button 308 so that the user cannot advance to a new step until the correct steps or parameters are selected, as indicated by the text generated by the help button 308. The console and screen shown in FIG. 3F are identical to those generated by a real lithography machine. In fact, as discussed later, if the user originally selects the manufacturing module 114, the user effectively is able to control an actual machine 310 in the cleanroom 302 and actually grow a real semiconductor component as the user is capable to control each aspect of the machine 310 through the monitor 350 and buttons 342-348 and 352 shown in FIG. 3F.

Some of the steps selected by the user need a certain time (waiting time) for being executed by the lithography machine. For these steps, a timer 354 is displayed on the screen 300, as illustrated in FIG. 3G. The user either waits until the waiting time has elapsed, or a skip button is displayed so that the user can skip the waiting time, for the training session. For an actual manufacturing session, the skipping step is not possible. During each of the steps previously discussed, an interaction button 307 is present on the screen 300, as shown in FIG. 3H, and it helps the user to return to the main training area in case of need.

Various control consoles 360 are generated by the training module 110, as illustrated in FIG. 3I, which are replicated from the lithography methods that are stored in the database module 130. If any selected lithography method includes movements associated with the substrate, as for example for the CMP machine, then such movements are shown to the user, as animations, as illustrated in FIG. 3J. The location of the substrate 320 can be tracked at any moment during the training exercise by pressing a corresponding instruction point 330 on a screen associated with the respective machine, as illustrated in FIG. 3K.

When the lithography process selected by the user is finalized, the user needs to leave the machine in the idle state, before he or she is allowed to continue to the next step. This procedure is indicated as an objective 304 on the screen 300 in FIG. 3L, and instruction points 330 are provided to point out to the user where he or she needs to be and which button or buttons he or she needs to activate. In addition, the training module 110 is configured to follow all the safety procedures associated with the manipulation of a wet chemical bench and/or any other procedures associated with the manipulation of dangerous substances. In this regard, the screen 300 would display the actual picture 370 of the machine 310, and would superimpose actual pictures 372, as shown in FIG. 3M, of the operations that the user needs to follow when, for example, pouring a certain solvent into a glass beaker. The substrate 320's status can be monitored (see FIG. 3N) at any step during the training procedure by simply clicking on a button on the screen 300. Other rules and procedures associated with the cleanroom may be stored in the database 130 and invoked by the training module 110 during the training process so that the user gets a full experience with regard to the cleanroom.

After successfully completing the steps suggested by the help button 308 for the selected lithography method, the user is taken back to the screen 200 in FIG. 2, and the training module in the panel 222 is shown as being completed. At this point, the user can select the assessment module 112, in the assessment panel 224. When the start button in the assessment panel is selected, the assessment module 112 is initiated and plural questions from the database 130 are selected, which are related to the lithography method just completed by the user. The assessment module 112 interactively tests the user about the various steps performed during the lithography method just completed, about safety measures related to that method, about safety measures about the chemical compounds used to practice that method, and about safety measures about various gases that are used in the machine practicing the lithography method. The module may be configured to end the assessment procedure if the user fails to correctly answer one or more of the questions. The assessment module 112 also offers a Q&A section, as shown in FIG. 2. This section asks the user one or more questions related to the lithography process just completed. A difference between the assessment process and the Q&A process is that the assessment process requires the user to perform all the steps learned during the training section in the exact order introduced in the training section while the Q&A section asks theoretical questions about the process, not necessarily related to the order of the steps.

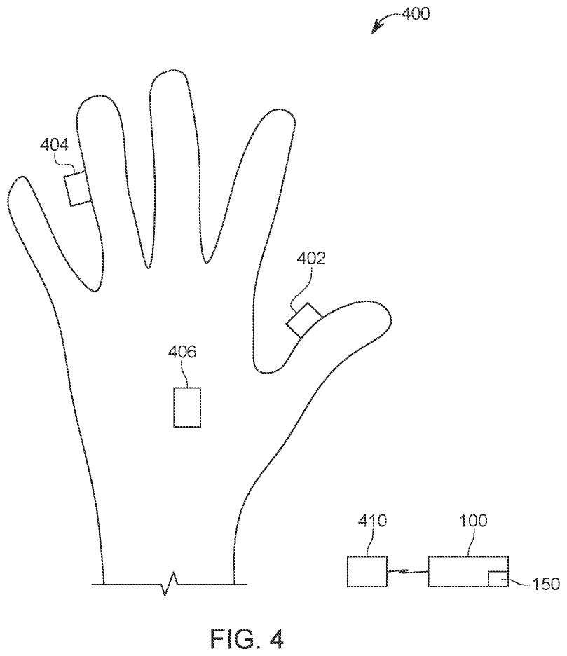

In one embodiment, the user may have its virtual experience of performing a semiconductor growing process enhanced by using one or more haptic devices. A haptic device is any device that is capable to change or alter its shape due to an external stimuli including, but not limited to an electric current, heat and pressure. One or more haptic devices 402, 404, and 406 may be attached to a glove 400 worn by the user, as illustrated in FIG. 4. In one application, the haptic devices may be attached directly to the user's hand or to other parts of the user's body. The haptic devices may be connected to the platform 100 in a wired or wireless manner, through a computing device 410 used by the user. The computing device 410 may be a personal computer, a laptop, a smartphone, a tablet, etc. A haptic module 150 is established in the platform 100, as illustrated in FIGS. 1 and 4, and the haptic module 150 is configured to generate various “feelings” to the user, which are associated with steps performed during the semiconductor growing process. For example, when a step of manually closing a door of a semiconductor growing chamber, or a step of pressing a start or stop button on the semiconductor growing machine is performed during the training part of the exercise, the haptic module 150 instructs the user's computing device 410 to provide a haptic experience through the one or more sensors 402-406 on the glove 400. This haptic experience may be a certain pressure that is proportional to the force used to close the door of the semiconductor growing chamber or to press the button of the semiconductor growing chamber. The same pressure feeling may be generated by the haptic module 150 when the user virtually picks up the substrate 320 or various components associated with the substrate 320, or opens or closes a pressure valve.

Further, the haptic module may be configured in software to generate either a pressure feeling or a light electrical current shock if the user performs a wrong step during the semiconductor growing process to alert the user about the mistake. For example, if the user leaves the semiconductor growing machine with a gas inside or with the gas or vacuum pump still running, such a pressure or electrical current shock can be provided to the user and a warning sign can be displayed on the screen. In another embodiment, the haptic module may generate a heat feeling for the user if the user is trying to press a wrong button, to touch a part of the semiconductor growing machine that he or she is not supposed to touch, or for any other action that does not comply with the recipe or protocol followed by the semiconductor growing process.

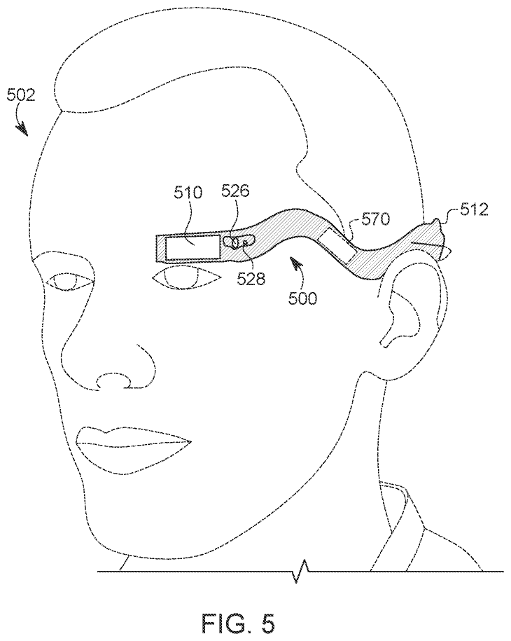

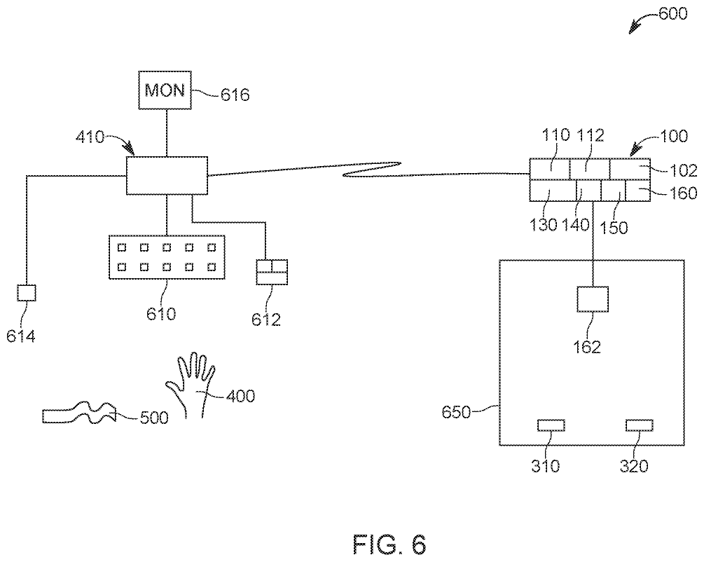

To further enhance the experience of the user, in addition or in exchange of the glove 400, the user may wear a virtual reality device 500, as illustrated in FIG. 5. The virtual reality device 500 is worn by the user 502 and includes a head-mounted display 510, which is supported by a band 512 that provides the desired fit of the display on the user's head (this configuration corresponds to FIG. 6 of U.S. Pat. No. 9,195,067 patent). Band 512 is configured such that when properly worn by the user, the display 510 can be positioned adjacent to the user's eye for making an image presented thereon viewable by the user. The band may receive an input from the user via a touch-based input 570 that is accessible to the user and is configured to receive a touch input from the user to execute a control function of the device or a function of another electronic device (e.g., device 410 shown in FIG. 4) that is connected or in communication with the haptic module 150.

Additional input structures can be added to band 512, as for example, a camera 526 and a sensor 528. The camera 526 can be used to capture an image or video at the user's discretion. The camera 526 can also be used by the device to obtain an image of the user's view of his or her environment to use in implementing augmented reality functionality. The sensor 528 can be, for example a light sensor that can be used by firmware or software associated with the camera 526. Similar wearable devices that include a screen may be used with the platform 500. The communication module 140 transmits information from the database module 130 to the screen 510, via the computing device 410, so that one or more pictures associated with the semiconductor processing or the semiconductor growing machine are superimposed on the visual field of the user as the user is performing the various steps of the growing process. For example, with regard to FIG. 3M, the screen 300 shows the actual picture 370 of the semiconductor growing machine and the virtual glass reality 500 can superimpose the picture 372 of a chemical related process associated with a specific step that is performed on the machine 310. In this way, the user can simply move his or her head around and still see the entire machine 310 and the additional picture 372 with the information related to the machine 310. Other virtual reality devices may be worn by the user in addition to or instead of the device 500.

In another embodiment, it is possible to provide one or more robotic actuators in the cleanroom that can be manipulated by the user remotely. A robotic module 160, as illustrated in FIG. 1, is configured to interact with the training module 110 of the platform 100 and offers the user the capability to manipulate one or more robotic actuators. For example, a system 600 that includes the computing device 410, which is used by the user, and the platform 100, which is remotely located and simulates the cleanroom, is shown in FIG. 6. The computing device 410 is shown in the figure having a keyboard 610, and/or a mouse 612, and/or the glove 400, and/or a joystick or similar device 614, and/or the virtual reality device 500. The computing device 410 also includes a display 616 for displaying the information supplied by the platform 100.

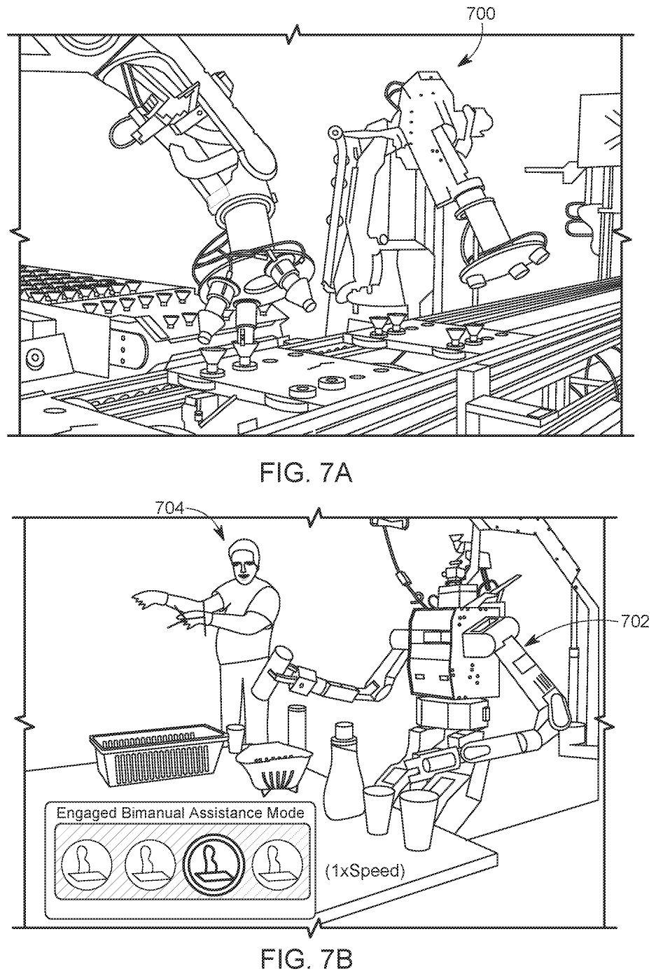

The figure also shows one or more actuators 162, which are controlled by the robotic module 160. The robotic module 160, through the communication module 140, offers the user's computing device 410 the possibility to control the actuator 162 with one of the peripheral device 400, 500, 600, 612, and/or 614. The actuators 162 may be robotic arms 700, as shown in FIG. 7A, that manipulate the substrate 320 and other materials that are used in the cleanroom, or a robotic device 702 as shown in FIG. 7B, which is configured to mimic the movements of the user 704.

The user thus can see the machine 310 and/or the various actuators 160 on the screen 616 of the computing device 410 and/or the display 510 of the virtual reality device 500. At the same time, the user can control the machine 310 through the keyboard 610, mouse 612, joystick 614, and/or glove 400. In addition, the user can control the one or more actuators 162 through the peripheral devices discussed above. The training module 110, the haptic module 150, and the robotic module 160 can coordinate their actions to offer the user a unified experience so that the user, for a given step of the semiconductor manufacturing process, can see the machine 310 using the monitor, can feel the substrate 320 using the one or more haptic devices, can open a chamber of the machine using the robotic actuators 162, and can see warnings using the display 510 of the virtual reality device 500. In one application, the robotic actuators 162 may be implemented in software to simulate various operations related to an oxidation furnace, thin film deposition tool, epitaxy tool, wet chemical bench, reactive ion etching equipment, chemical mechanical polisher, thermal/flash/laser annealing tools, etc. However, in another application, it is possible to have actual robotic actuators, which are located remotely, either in the actual cleanroom or at any other location, and the user is provided with the interface to operate these physical robotic actuators. A robotic actuator can be a machine that automates one or more steps in the cleanroom, for example, carrying the waver from a storage location to the selected machine, or it can be an actual humanoid robot that walks and performs human-like tasks, as shown in FIGS. 7A and 7B. No matter the actual implementation of the robotic actuator, and no matter whether the robotic actuator is implemented strictly in software or as a combination of software and hardware, with actual moving parts, the user is offered through the organizational module 102, the communication module 140 and the robotic module 160 the capability to see, live or in a simulated manner, the robotic actuator and its responses to the commands sent by the user. In other words, when the user uses its computing device 410, with the associated peripherals 400, 500, 610, 612, 614 and/or 616, the user is capable to watch on the display 616 the robotic actuator, its movement, and its reaction to the commands input by the user through one or more of the peripherals. Note that by using the glove 400, the user may control the robotic actuator with natural human gestures, as the user would be actually located in the cleanroom.

The system 600 discussed above was mainly discussed for the purpose of offering any user, no matter where located, the capability to interact with a virtual cleanroom, which can be as accurate as an actual cleanroom. This system offers the user the possibility to familiarize with an actual cleanroom, become proficient into manipulating any machine in the cleanroom, learn how to manufacture a semiconductor device with one or more of these machines, and also learn the processes and associated parameters that are run by these machines. The user is also offered the possibility to learn any safety measure that needs to be observed into these facilities. At the end of the learning phase, the user is tested to make sure that he or she masters the desired techniques, and a certification may be awarded to the user indicated that the user can safely enter a cleanroom.

However, the system 600 and its components can also be used to actually manufacture semiconductor devices on a per-need basis in an actual cleanroom, although the user is not physically present in that cleanroom. For this goal, the user is assumed to be an expert in the field and the user knows not only to manipulate the machines available in the cleanroom, but actually the user knows what steps the machines need to perform to grow the desired semiconductor device. For example, suppose that the user needs to manufacture N transistors (any other semiconductor device may work) for research purpose, prior to launching a product, where N can be in the tens or hundreds of units. The user designs the desired transistor, defines the size of each region of the transistor, the material that makes up each part of the transistor, and the doping of the source and the drain. Many other parameters of the transistor may be controlled and selected at this stage.

After the design of the transistor is finalized, the user can log in into the platform 100, using the system 600. It is noted that for using an actual cleanroom 650 (see FIG. 6), which is controlled by the platform 100 and indirectly by the user's computing system 410, safety measures are required so that an unauthorized user cannot control the machines in the cleanroom. Thus, the user needs to make an account with the platform 100, and only if authorized by the operator of the platform 100, the user can take control of one or more machines in the cleanroom. The account generated by the platform 100 may allow the user to use a given number of the machines present in the cleanroom, for a certain day or days, for selected times. After the user is allowed to virtually enter into the actual cleanroom and use the desired machine, the user can control that machine with one or more of the peripherals of the computing device 410, through the manufacturing module 114 of the platform 100. The manufacturing module 114 coordinates all the commands or requests from the computing device 410, and makes sure that the capabilities of the existing machines in the cleanroom are not exceeded. For example, the user can use the haptic glove 400 to direct the robotic actuator 162 to physically select a waver 320 from a given location in the cleanroom 650, and then to place the wafer in the desired machine 310. The manufacturing module 114 ensures that the required wafers are stored in the cleanroom and the materials needed to be grown on these wafers are available. If any material is missing or the selected machine cannot achieve the parameters desired by the user, for example, pressure, temperature, etc., the manufacturing module 114 sends a message to the computing device 410 to inform that the selected material or parameter of the machine cannot be fulfilled.

The user needs to follow the protocols in place established in the cleanroom to be able to open, close and run the machine 310. The user also needs to interact with the selected machine 310, through the monitor 350 and one or more buttons 352 that are present on the machine 310, see FIG. 3F, to program the machine to manufacture the desired transistor. One or more valves associated with the machine for selected the desired doping and other materials may be physically actuated with the robotic actuator 162 through interaction with the glove 400, virtual reality device 500, keyboard 610, mouse 612, and/or joystick 614. All these operations may be performed while the user is sitting in front of his or her computing device 410, which can be meters or kilometers or thousand of kilometers away from the actual cleanroom 650. Note that the platform 100 could be implemented in the cloud, at any location on earth. However, the platform 100 could also be implemented close to the cleanroom or even inside the cleanroom. Once the transistors are manufactured, the operator of the cleanroom packages them in protective material and ships them to the user. In this way, a user that needs a small batch of semiconductor devices, does not have to rent or own the entire cleanroom, but can only rent the desired machine for a desired amount of time whenever the machine is available. The operator of the cleanroom makes sure that all the materials needed for manufacturing the semiconductor device are in place, all the gases for the various steps of the semiconductor growing are available, and the cleanroom infrastructure is running.

Thus, the platform 100 discussed in the above embodiments can be used for teaching, learning, practicing, assessing, and manufacturing any semiconductor device/process for which a corresponding machine is present in the facility. While the present embodiments discussed only one such machine and listed only a couple of known semiconductor manufacturing methods, one skilled in the art would know that there are many other semiconductor manufacturing methods that may be implemented in a given cleanroom and the present embodiments are not limited to the listed methods.

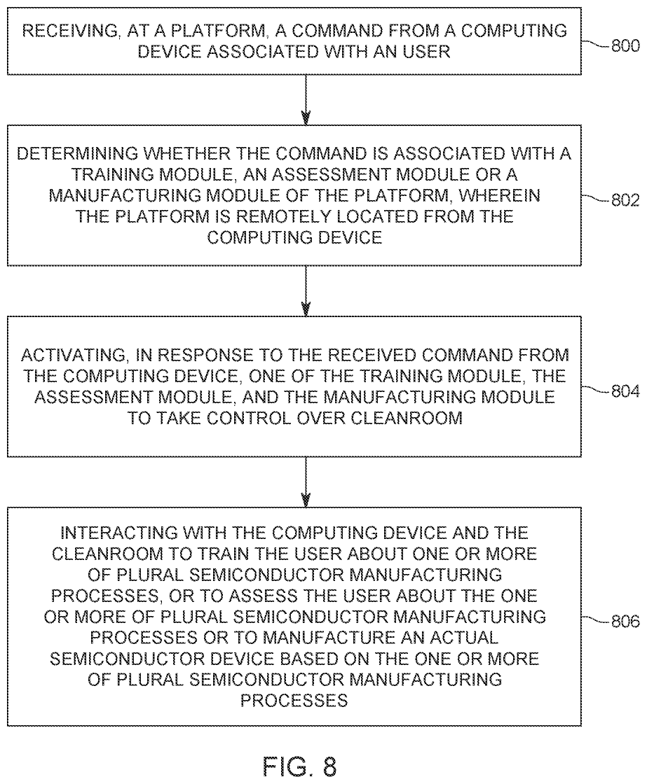

A method for connecting a user to a cleanroom facility based on the platform 100 introduced above is now discussed with regard to FIG. 8. The method includes a step 800 of receiving, at the platform 100, a command from a computing device 410 associated with an user, a step 802 of determining whether the command is associated with a training module 110, an assessment module 112 or a manufacturing module 114 of the platform 100, where the platform 100 is remotely located from the computing device 410, a step 804 of activating, in response to the received command from the computing device 410, one of the training module 110, the assessment module 112, and the manufacturing module 114 to take control over cleanroom 650, and a step 806 of interacting with the computing device 410 and the cleanroom 650 to train the user about one or more of plural semiconductor manufacturing processes, or to assess the user about the one or more of plural semiconductor manufacturing processes or to manufacture an actual semiconductor device based on the one or more of plural semiconductor manufacturing processes

In one embodiment, the method further includes a step of activating the training module to offer to the computing device a choice of the one or more of plural semiconductor manufacturing processes, a step of receiving at an organizational module of the platform, from the computing device, a selected semiconductor manufacturing process, and a step of preparing a machine in the cleanroom to execute the selected semiconductor manufacturing process.

The method may further include a step of interacting with a database module of the platform to provide the computing device with each step of the selected semiconductor manufacturing process, and also with (1) interaction points for guiding the user to required positions inside the cleanroom, (2) hints for performing the steps of the semiconductor manufacturing process, and (3) images related to the interaction points. In one application, the method may further include a step of receiving at an organizational module of the platform, from the computing device, a selected semiconductor manufacturing process, a step of preparing a set of questions from a database module of the platform, about a machine in the cleanroom that is associated with the selected semiconductor manufacturing process, and a step of grading answers for the set of questions associated with the selected semiconductor manufacturing process, and providing a fail or pass indication to the user.

The method may further include a step of receiving at the manufacturing module, from the computing device, a selected semiconductor device to be manufactured and a selected semiconductor manufacturing process to be used to manufacture the selected semiconductor device, and a step of preparing an actual machine in the cleanroom to execute the selected semiconductor manufacturing process. In one application, the method may include a step of receiving one or more commands from a glove having haptic sensors that are controlled by a haptic module of the platform, and a step of generating, within the haptic module, haptic sensor interactions so that the user of the computing device experiences actual sensations related to a selected semiconductor manufacturing process.

The method may further include a step of transferring actual images from the cleanroom to a display of a virtual reality device worn by the user, and a step of transferring virtual images, associated with the one or more of plural semiconductor manufacturing processes, on a display of the computing device of the user. The cleanroom may be an actual cleanroom facility or a virtual cleanroom. The method may also include manipulating robotic actuators located in the cleanroom through a robotic module of the platform.

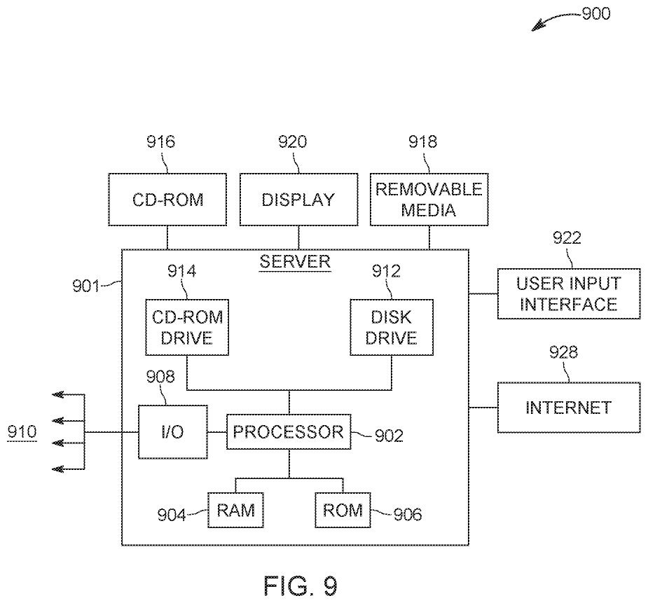

The platform 100 discussed above may be implemented into a server or computer system or computer device as illustrated in FIG. 9. Hardware, firmware, software or a combination thereof may be used to perform the various steps and operations described herein. Computing device 900 of FIG. 9 is an exemplary computing structure that may be used in connection with such a system.

Computing device 900 suitable for performing the activities described in the exemplary embodiments may include a server 901. Such a server 901 may include a central processor (CPU) 902 coupled to a random access memory (RAM) 904 and to a read-only memory (ROM) 906. ROM 906 may also be other types of storage media to store programs, such as programmable ROM (PROM), erasable PROM (EPROM), etc. Processor 902 may communicate with other internal and external components through input/output (I/O) circuitry 908 and bussing 910 to provide control signals and the like. Processor 902 carries out a variety of functions as are known in the art, as dictated by software and/or firmware instructions.

Server 901 may also include one or more data storage devices, including hard drives 912, CD-ROM drives 914 and other hardware capable of reading and/or storing information, such as DVD, etc. In one embodiment, software for carrying out the above-discussed steps may be stored and distributed on a CD-ROM or DVD 916, a USB storage device 918 or other form of media capable of portably storing information. These storage media may be inserted into, and read by, devices such as CD-ROM drive 914, disk drive 912, etc. Server 901 may be coupled to a display 920, which may be any type of known display or presentation screen, such as LCD, plasma display, cathode ray tube (CRT), etc. A user input interface 922 is provided, including one or more user interface mechanisms such as a mouse, keyboard, microphone, touchpad, touch screen, voice-recognition system, etc.

Server 901 may be coupled to other devices, such as user's computing system, robotic actuators, haptic sensors, detectors, semiconductor growing machines, etc. The server may be part of a larger network configuration as in a global area network (GAN) such as the Internet 928, which allows ultimate connection to various landline and/or mobile computing devices.

The disclosed embodiments provide a platform that facilitates interaction between a user's computing system and a cleanroom, so that the user can learn to use the cleanroom, and/or is assessed about the cleanroom, and/or can use the cleanroom to remotely manufacture a desired semiconductor component. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A system that connects a user to a cleanroom facility, the system comprising:
a computing device configured to receive a command from a user; and
a platform remotely located from the computing device, wherein the platform is configured to communicate with the computing device and with a cleanroom, the platform including a training module, an assessment module, and a manufacturing module,
wherein the platform is configured to, in response to receiving the command from the computing device, activate one of the training module, the assessment module, and the manufacturing module to take control over the cleanroom.

2. The system of claim 1, wherein the training module is activated and the training module is configured to offer to the computing device a choice of semiconductor manufacturing processes.

3. The system of claim 2, wherein the platform further includes an organizational module, which is configured to receive from the computing device a selected semiconductor manufacturing process, and to prepare a machine in the cleanroom to execute the selected semiconductor manufacturing process.

4. The system of claim 3, wherein the training module is further configured to interact with a database module of the platform, to provide the computing device with each step of the selected semiconductor manufacturing process, and also with (1) interaction points for guiding a user to required positions inside the cleanroom, (2) hints for performing the steps of the semiconductor manufacturing process, and (3) images related to the interaction points.

5. The system of claim 2, wherein the platform further includes an organizational module, which is configured to receive from the computing device a selected semiconductor manufacturing process, and to prepare a set of questions from a database module of the platform, about a machine in the cleanroom that is associated with the selected semiconductor manufacturing process.

6. The system of claim 5, wherein the training module is further configured to grade answers to the set of questions associated with the selected semiconductor manufacturing process, and to provide a fail or pass indication to the user.

7. The system of claim 2, wherein the platform further includes a manufacturing module, which is configured to receive from the computing device a selected semiconductor device to be manufactured and a selected semiconductor manufacturing process to be used to manufacture the selected semiconductor device, and to prepare an actual machine in the cleanroom to execute the selected semiconductor manufacturing process.

8. The system of claim 1, further comprising:
a glove having haptic sensors that are controlled by a haptic module of the platform, and the haptic module is configured to generate haptic sensor interactions so that the user of the computing device experiences actual sensations related to a selected semiconductor manufacturing process.

9. The system of claim 8, further comprising:
a virtual reality device that is configured to be worn by the user and to display images associated with a selected machine and process in the cleanroom.

10. The system of claim 1, wherein the cleanroom is an actual cleanroom facility.

11. The system of claim 1, further comprising:
robotic actuators which are located in the cleanroom and are configured to respond to the command from the computing device for moving a wafer inside the cleanroom.

12. A method for connecting a user to a cleanroom facility, the method comprising:
receiving at a platform a command from a computing device associated with a user;
determining whether the command is associated with a training module, an assessment module, or a manufacturing module of the platform, wherein the platform is remotely located from the computing device;
activating, in response to the received command from the computing device, one of the training module, the assessment module, and the manufacturing module to take control over cleanroom; and
interacting with the computing device and the cleanroom to train the user about one or more of plural semiconductor manufacturing processes, or to assess the user about the one or more of plural semiconductor manufacturing processes, or to manufacture an actual semiconductor device based on the one or more of plural semiconductor manufacturing processes.

13. The method of claim 12, further comprising:
activating the training module to offer to the computing device a choice of the one or more of plural semiconductor manufacturing processes;
receiving at an organizational module of the platform, from the computing device, a selected semiconductor manufacturing process; and
preparing a machine in the cleanroom to execute the selected semiconductor manufacturing process.

14. The method of claim 13, further comprising:
interacting with a database module of the platform to provide the computing device with each step of the selected semiconductor manufacturing process, and also with (1) interaction points for guiding the user to required positions inside the cleanroom, (2) hints for performing the steps of the semiconductor manufacturing process, and (3) images related to the interaction points.

15. The method of claim 13, further comprising:
receiving at an organizational module of the platform, from the computing device, a selected semiconductor manufacturing process;
preparing a set of questions from a database module of the platform, about a machine in the cleanroom that is associated with the selected semiconductor manufacturing process; and
grading answers for the set of questions associated with the selected semiconductor manufacturing process, and providing a fail or pass indication to the user.

16. The method of claim 12, further comprising:
receiving at the manufacturing module, from the computing device, a selected semiconductor device to be manufactured and a selected semiconductor manufacturing process to be used to manufacture the selected semiconductor device; and
preparing an actual machine in the cleanroom to execute the selected semiconductor manufacturing process.

17. The method of claim 12, further comprising:
receiving one or more commands from a glove having haptic sensors that are controlled by a haptic module of the platform; and
generating, within the haptic module, haptic sensor interactions so that the user of the computing device experiences actual sensations related to a selected semiconductor manufacturing process.

18. The method of claim 17, further comprising:
transferring actual images from the cleanroom to a display of a virtual reality device worn by the user; and
transferring virtual images, associated with the one or more of plural semiconductor manufacturing processes, on a display of the computing device of the user.

19. The method of claim 12, wherein the cleanroom is an actual cleanroom facility.

20. The method of claim 12, further comprising:
manipulating robotic actuators located in the cleanroom through a robotic module of the platform.

21. A platform for connecting a user to a cleanroom facility, the platform comprising:
a communication module configured to receive a command from a computing device of an user;
a training module configured to generate a step by step procedure for each of one or more of plural semiconductor manufacturing processes;
an assessment module configured to generate one or more questions about the one or more plural semiconductor manufacturing processes;
a manufacturing module configured to control one or more machines in a cleanroom for using the one or more plural semiconductor manufacturing processes;
an organizational module configured to determine whether the command is associated with the training module, the assessment module, or the manufacturing module and to activate, in response to the received command, one of the training module, the assessment module, and the manufacturing module to take control over the cleanroom; and
a communication module that interacts with the computing device and the cleanroom to train the user about the one or more plural semiconductor manufacturing processes, or to assess the user about the one or more plural semiconductor manufacturing processes, or to manufacture an actual semiconductor device based on the one or more plural semiconductor manufacturing processes.
